(19) United States
(12) Patent Application Publication
(10) Pub. No.: US 2014/0215532 A1
(43) Pub. Date: Jul. 31, 2014

(54) SYSTEM AND METHOD FOR DELIVERING MEDIA CONTENT TO WIRELESS ELECTRONIC DEVICE

(71) Applicant: Spectrum Bridge, Inc., Lake Mary, FL (US)

(72) Inventors: Jeffery C Schmidt, Orlando, FL (US); Peter Stanforth, Winter Springs, FL (US)

(73) Assignee: Spectrum Bridge, Inc., Lake Mary, FL (US)

(21) Appl. No.: 14/162,910

(22) Filed: Jan. 24, 2014

Related U.S. Application Data
(60) Provisional application No. 61/756,491, filed on Jan. 25, 2013.

(51) Int. Cl. H04N 21/2668

(52) U.S. Cl. CPC H04N 21/2668
USPC 725/74

(57) ABSTRACT

The present disclosure relates to a system and method for delivering media content to a wireless electronic device within a geographic coverage area associated with a venue. In some embodiments, a venue manager may identify media content to be broadcast within the geographic coverage area associated with the venue by the wireless TV transmitter; and send a media content request to a media server, the request instructing the media server to include the identified media content in a content feed sent to the wireless TV transmitter for broadcast in the geographic coverage area associated with the venue. In other embodiments, an interactive TV transmitter may identify media content to be broadcast within the geographic coverage area associated with the venue, multiplex the identified media content with other media content using a multiplexer, and broadcast the multiplex in the geographic coverage area associated with the venue.

### RELATED APPLICATION DATA

This application claims the benefit of U.S. Provisional Patent Application No. 61/756,491, filed Jan. 25, 2013, the disclosure of which is incorporated herein by reference in its entirety.

### TECHNICAL FIELD

The technology of the present disclosure relates generally to wireless communications and, more particularly, to a system and method for delivering media content to a wireless electronic device.

### BACKGROUND

The portability of wireless electronic devices is becoming increasingly prevalent, due much in part to their reduction in size and/or integration with other devices. Some wireless electronic devices may include a digital television tuner to wirelessly receive digital television broadcasts. Services have been developed and deployed to provide wireless electronic devices with such broadcasts, but many of these services broadcast using a single high-power, high-site, transmitter in a manner similar to that by which analog TV broadcasts were broadcast. This conventional approach provides no differentiation or ability to target content to specific viewers.

### BRIEF DESCRIPTION OF THE DRAWINGS

FIG. 1 is a schematic view of an exemplary media distribution system.

FIG. 2 is a schematic view of an exemplary media server.

FIG. 3 is a schematic view of an exemplary wireless electronic device.

FIGS. 4 and 5 are flow diagrams representing exemplary actions taken by various components of the exemplary media distribution system of FIG. 1.

FIG. 6 is a schematic view of another exemplary media distribution system.

FIGS. 7 and 8 are flow diagrams representing exemplary actions taken by various components of the exemplary media distribution system of FIG. 6.

### DETAILED DESCRIPTION

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

The present disclosure provides a system and method in which media content (e.g., television content) can be wirelessly delivered (e.g., broadcast) to one or more wireless electronic devices. The capability of wireless electronic devices to receive and display digital television broadcasts, coupled with the availability of configurable wireless TV transmitters (e.g., micro-TV transmitters), Wi-Fi, cloud-based computing technology and licensed and unlicensed UHF broadband spectrum, enables the ability to target television viewers with content relevant to preferences or selections of the viewer, and/or relevant to the location of the viewer. The system and method may utilize one or more sources of media content (e.g., content from a cloud based media server, a local media server, a remote and/or local receiver and video re-encoder, etc.) in conjunction with content management (e.g., control over selection of the media content using one or more of local venue control, network control, and/or user control) to provide media content to one or more wireless electronic devices in a geographic coverage area associated with the venue.

For example, in some embodiments, the media content that is provided to the one or more wireless electronic devices may be local content that is made available from a provider or source for broadcast to the wireless electronic device. Local content, as used herein, is media content specific to the venue in which it is broadcast for consumption by one or more wireless electronic devices due to the presence of the one or more wireless electronic devices at a geographic area within the transmission range of the wireless TV transmitter. In one example, the local content may be locally generated television content that is uploaded live (e.g., via IP) and broadcast (e.g., in ATSC format) to wireless electronic devices within the geographic coverage area associated with the venue. In another example, the local content may be television content that is prerecorded and derived from a local or remote source, but is broadcast to the wireless electronic device because of the geographic relationship between the wireless TV transmitter and the wireless electronic device. One exemplary implementation of the broadcast of local content is the broadcast of television content to patrons within a restaurant or bar (e.g., the broadcast of content associated with a trivia game, the broadcast of happy hour specials, video of a locally-filmed event, etc.). Another exemplary implementation of the broadcast of local content is the broadcast of television content to attendees at a sporting event (e.g., the broadcast of video feed from the event, the broadcast of advertisements, the broadcast of concessions specials, etc.). Hence, the system and method of the present disclosure may provide the ability to broadcast localized media content to one or more wireless electronic devices within that location.

In other embodiments, the media content that is provided to the one or more wireless electronic devices may be extracted from a remote prerecorded or live television source (e.g., news, sports, sitcom, or other third party or network broadcast). Examples of a remote source include cable TV providers, satellite TV providers, etc. In one example, the media content may be television content from the remote source that is captured by the system and is re-transmitted by the system (e.g., a re-broadcast of an over-the-air broadcast that is received by the system without significant delay or alteration). Hence, the system and method of the present disclosure may provide the ability to supplement the broadcast coverage of television content broadcast from a high-power transmitter to a location that would otherwise have poor or inadequate reception. In another example, the media content may be television content that is broadcast from a library or repository of content (e.g., remote on demand content supplied by a “cloud-based” content service that offers TV programs, movies, etc.). The content stored in the library or repository of content may include commercially-available content and/or user-specific content that has been uploaded, stored, marked as a favorite, etc. by the user of the venue manager or wireless electronic device.

The term “venue”, as used herein, may refer to a location having a predefined geographic area. In some embodiments, the venue may be a geographic area associated with a physical structure (e.g., a restaurant, bar, stadium, racetrack, home, place of business, airport, etc.). In other embodiments, the venue may be a geographic area associated with an event (e.g., a concert, conference, meeting, etc.). Media content may be broadcast by the wireless TV transmitter in a geographic coverage area associated with the venue. The geographic coverage area may overlap the geographic area of the venue, and the geographic coverage area may be smaller than, equivalent to, or larger than the geographic area of the venue.

While embodiments of the system and method of the present disclosure are discussed herein primarily in the context of television-based multimedia content, it will be understood that the system and method of the present disclosure may be utilized in connection with other types of media content. For example, in some embodiments, the system and method may be configured to deliver audio-based multimedia content to one or more wireless devices. In other embodiments, the system and method may be configured to deliver UDP/IP data to one or more mobile wireless devices.

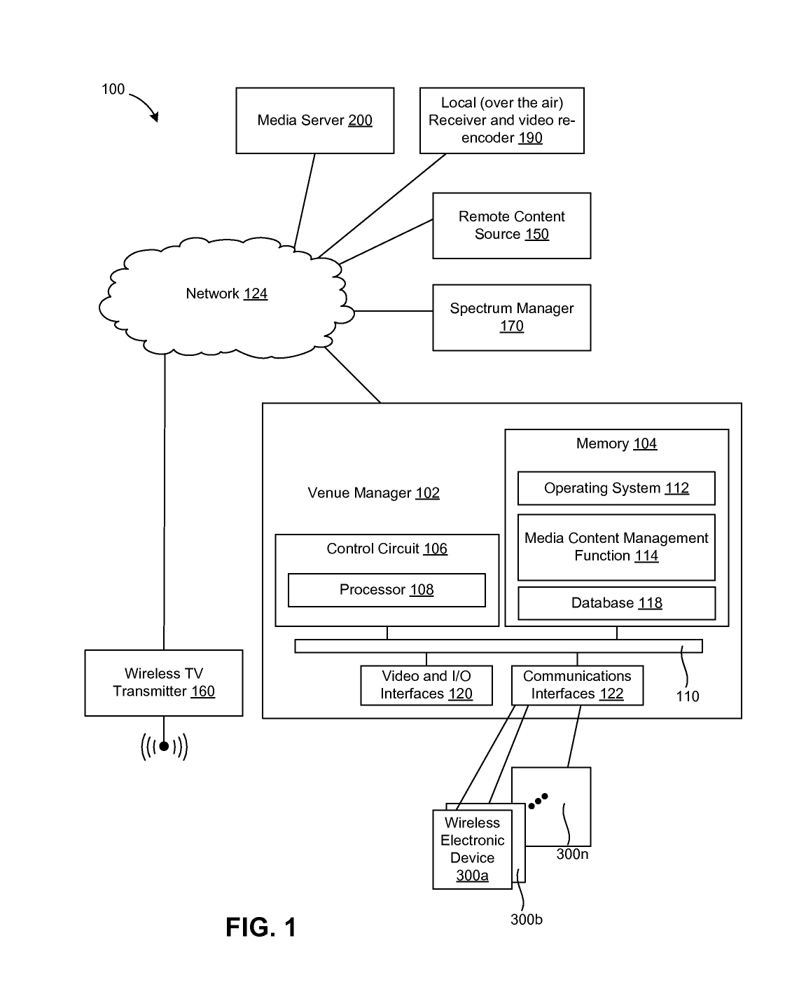

Referring now to FIG. 1, an exemplary media content distribution system is shown at 100. The exemplary media content distribution system 100 may include a venue manager 102, a wireless TV transmitter 160, and a media server 200. The exemplary media content distribution system 100 may further include a remote content source 150, a spectrum manager 170, and/or a local (over the air) receiver and video re-encoder 190. The media distribution system 100 may be configured to broadcast media content to one or more wireless electronic devices 300a-300n.

The venue manager 102 may be configured to execute various functions for managing the specific media content that is broadcast to the one or more wireless electronic devices 300a-300n. As discussed more detail below, the venue manager 102 may be configured to communicate with the media server 200. The venue manager 102 may additionally be configured to communicate with the one or more wireless electronic devices 300a-300n, the spectrum manager 170, and/or the wireless TV transmitter 160. The venue manager 102 may be configured to identify media content to be broadcast within the geographic coverage area associated with a venue by the wireless TV transmitter 160, and send a media content request to the media server 200 instructing the media server 200 to include the identified media content in a content feed sent to the wireless TV transmitter 160 for broadcast in the geographic coverage area associated with the venue. Such features allow for control over the localized broadcast of media content.

The venue manager 102 may include a memory 104 for storing data, logic routine instructions, computer programs, files, operating system instructions, and the like. The memory 104 is considered a non-transitory computer readable medium and may comprise several devices, including volatile and non-volatile memory components. Accordingly, the memory 104 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the venue manager 102 may be controlled by a control circuit 106. The control circuit 106 may include one or more processors 108 used to execute instructions that carry out a specified logic routine(s). The control circuit 106 and the components of the memory 104 may be coupled using a local interface 110. The local interface 110 may be, for example, a data bus with accompanying control bus, a network, or other subsystem.

The memory 104 may store an operating system 112 that is executed by the processor 108 to control the allocation and usage of resources in the venue manager 102, as well as provide basic user interface features. Specifically, the operating system 112 controls the allocation and usage of the memory 104, the processing time of the processor 108 dedicated to various applications being executed by the processor 108, and the peripheral devices, as well as performing other functionality. In this manner, the operating system 112 serves as the foundation on which applications, such as the media content management function 114, depend as is generally known by those with ordinary skill in the art. The operating system 112 also may control much of the user interface environment presented to a user, such as features of the overall graphical user interface (GUI) for the system.

The memory 104 may store a media content management function 114. In one embodiment, the media content management function 114 is embodied as one or more computer programs (e.g., one or more software applications including compilations of executable code). The media content management function 114 may be configured to identify media content to be broadcast within the geographic coverage area associated with the venue by the wireless TV transmitter. This identification may be made based on selections and/or preferences set at the venue manager and/or selections and/or preferences received from the one or more wireless electronic devices 300a-300n located in the geographic coverage area associated with the venue.

For example, the media content management function 114 may identify media content based on a user selection at the venue manager. In another example, the media content management function 114 may identify media content based on a broadcast request received from a wireless electronic device 300a-300n within the geographic coverage area associated with the venue. This may allow a user of the wireless electronic device to interact with the media server via an IP based wireless connection (e.g., by submission of viewing preferences, geo-location data, channel selection, location, or content selection(s) from the wireless electronic device).

The media content management function 114 may be configured to analyze the identification of media content made at the venue manager 102 and/or the broadcast request received from a wireless electronic device. In one embodiment, the media content management function 114 may analyze a selection made at the venue manager 102 and/or the broadcast request received from a wireless electronic device 300a-300n in view of one or more criteria set at the venue manager 102. The criteria set at the venue manager may include access/authorization information (e.g., pertaining to the identity of the wireless electronic device, the allotted duration that a given wireless electronic device is permitted to use the system, etc.), as well as information pertaining to the type of content (e.g., genre, duration, cost, etc.) and the overall number of channels that may be broadcast. The criteria set at the venue manager may additionally or alternatively include preference information from the media server or remote content source (e.g. network provider). This information may be used to tailor the access and/or type of content broadcast via the media content distribution system 100. For example, the media content management function 114 may require authentication of the requesting wireless electronic device in order to effectuate the broadcast of the identified media content. In another example, a request for media content having a given genre (e.g., soap opera) may not be permitted when the criteria requires that the media content has a different genre (e.g., sports).

In another embodiment, the analysis performed by the media content management function 114 may include comparison of the identified media content to the media content that is presently being broadcast. For example, if the media content management function 114 determines that the identified media content is presently being broadcast, the media content management function 114 may send the identity of the channel to the wireless electronic device in lieu of contacting the media server 200.

In another embodiment, the analysis performed by the media content management function 114 may include a determination of whether a channel is available for broadcasting the identified content. If the number of wireless electronic devices is equal to, or less than the number of channels that are provided, each wireless electronic device in a venue can select or reserve its own channel with no contention, via the mobile application (described above). It is possible that the number of wireless electronic devices registered or capable of interacting with the TV transmitter is greater than the number of available channels. In an example where X channels are available, if more than X viewers exist within a venue at a given time, there is a possibility that each may view desired content due to synergy in viewing choices. However, as the number of viewers increase, the probability increases that viewers may want to access content that is available, but not currently streamed.

Accordingly, where all available channels are occupied, a determination may be made whether a new item of media content should replace media content that is presently being broadcast.

In an embodiment where the media content is set based on selection at the venue manager (absent any input from the one or more wireless electronic devices 300a-300n), this determination may be made based solely on the instruction of the user at the venue manager to replace an existing item of media content with a new item of media content.

In another embodiment where one or more selections may be provided by the one or more wireless electronic devices 300a-300n, the one or more selections may be weighed against one another for determining the specific item(s) of media content to be broadcast within the geographic coverage area. The media content management function 114 may identify the media content based on factors such as the number of requests for a given content, the frequency of the requests for the given content, the cost of a given content, the duration of a content. Also, the weight of a given selection may vary depending on the status of the device that has requested the selection. For example, certain wireless electronic devices may be given a prioritized status (e.g., based on membership, payment, etc.) that may influence the identification of the media content. Furthermore, the one or more selections may be weighed against one another, and in view of one or more criteria set at the venue manager 102 as discussed above.

The media content management function 114 may further be configured to send a media content request to the media server 200, the media content request identifying the media content. In some embodiments, a determination to send the media content request may be a result of the analysis of the identification of media content made at the venue manager 102 and/or the broadcast request received from a wireless electronic device. The request may instruct the media server 200 to include a stream of the identified media content in a content feed sent to the wireless TV transmitter 160 for broadcast in the geographic coverage area associated with the venue. In some embodiments where the identified media content includes content from the venue manager (e.g., local content), the media content request may include such content (e.g., the local content may be included, or the media content management function 114 may stream the content to the media server 200). In other embodiments, the media content management function 114 may send the local content to the media server 200 in advance of a media content request for storage at the media server 200.

The media content request may include the identification of one or more items of media content. In an embodiment where the content feed is a multiplex of media content streams, the media content request may only include the identity of the newly selected media content (as well as the media content it will replace if the newly selected media content is replacing an existing stream of media content). In another embodiment where the content feed is a multiplex of media content streams, the media content request may include the identity of all of the items of media content, including the newly selected media content.

Accordingly, the media content management function 114 may control and/or influence the content that is broadcast from the media server 200 to the one or more wireless electronic devices 300a-300n based on one or more input preferences/criteria from the one or more wireless electronic devices 300a-300n and/or the venue manager 102 itself. Exemplary embodiments showing the operation of the media content management function 114 are described in more detail below.

The memory 104 may store a database 118. The database 118 may store information used by the broadcast channel determination function 114. For example, the database 118 may store a history of media content selections and requests from the user of the venue manager and/or users of the one or more wireless electronic devices. The database 118 may additionally or alternatively store criteria set at the venue manager and/or received from the media server or remote content source, such as access/authorization information (e.g., pertaining to the identity of the wireless electronic device, the allotted duration that a given wireless electronic device is permitted to use the system, etc.), as well as information pertaining to the type of content (e.g., genre, duration, cost, etc.) and the overall number of channels that may be broadcast. This information may be used in analyzing the identification of media content made at the venue manager 102 and/or the broadcast request received from a wireless electronic device. The database 118 may additionally or alternatively store a listing (including the identity, location, availability, cost, duration, etc.) of available content that may be used in selecting a media content. The database 118 may additionally or alternatively store local content.

The venue manager 102 may have various video and input/output (I/O) interfaces 120 as well as one or more communications interfaces 122. The I/O interfaces 120 may be used to operatively couple the venue manager 102 to various peripherals (not shown), such as a display, a keyboard, a mouse, a video camera, and/or one or more other suitable input devices. The communications interfaces 122 may include for example, a modem and/or a network interface card. The communications interfaces 122 may enable the venue manager 102 to send and receive data signals, voice signals, video signals, and the like to and from the media server 200, the one or more wireless electronic devices 300a-300n, the spectrum manager 170, and/or the wireless TV transmitter 160 via an external network 124 (e.g., the Internet, a wide area network (WAN), a local area network (LAN), direct data link, or similar systems).

The venue manager 102 may be in communication with the media server 200 (e.g., via the network 124). The media server 200 may be configured to execute various functions for configuring a plurality of individually available media streams from a variety of sources in accordance with the parameters received from the venue manager 102. As discussed more detail below, the media server 200 may be configured to communicate with the venue manager 102 and the wireless TV transmitter 160, and may additionally be configured to communicate with the spectrum manager 170 and one or more sources of remote content 150. The media server 200 may be configured to receive a media content request from the venue manager 102, the media content request including an identity of media content that is to be broadcast within the geographic coverage area associated with the venue, the request instructing the media server to include the identified media content in a content feed sent to the wireless TV transmitter 160 for broadcast in the geographic coverage area associated with the venue. The media server 200 may also be configured to send the identified media content in a content feed to the wireless TV transmitter 160 to be broadcast within the geographic coverage area associated with the venue.

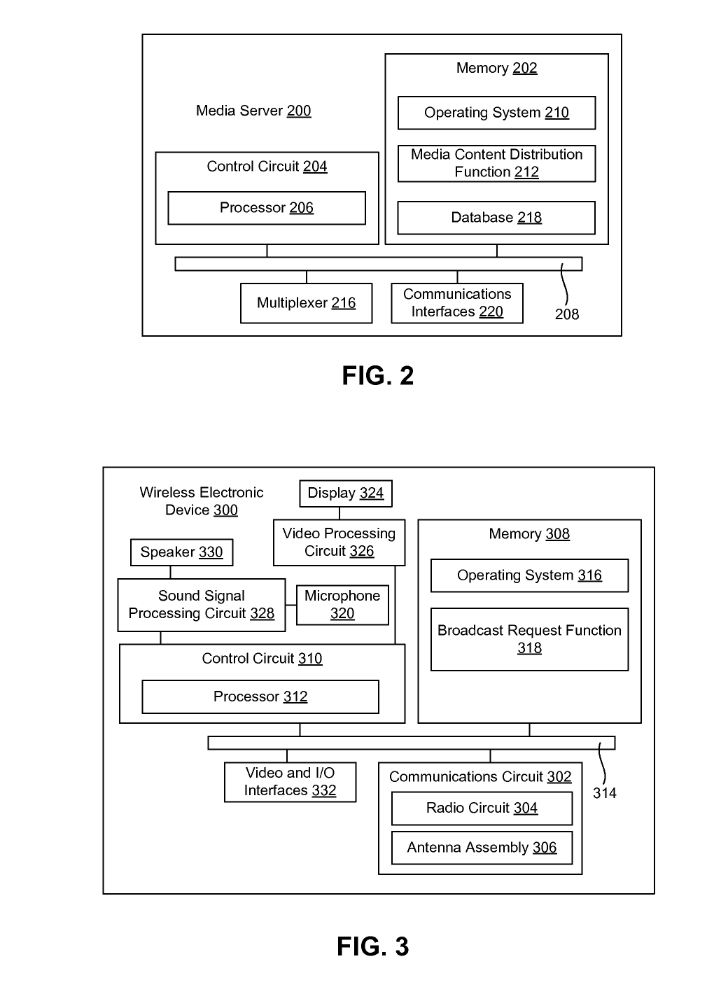

An exemplary media server 200 is shown in FIG. 2. The media server 200 may include a memory 202 for storing data, logic routine instructions, computer programs, files, operating system instructions, and the like. The memory 202 is considered a non-transitory computer readable medium and may comprise several devices, including volatile and non-volatile memory components. Accordingly, the memory 202 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the media server 200 may be controlled by a control circuit 204. The control circuit 204 may include one or more processors 206 used to execute instructions that carry out a specified logic routine(s). The control circuit 204 and the components of the memory 202 may be coupled using a local interface 208. The local interface 208 may be, for example, a data bus with accompanying control bus, a network, or other subsystem.

The memory 202 may store an operating system 210 that is executed by the processor 206 to control the allocation and usage of resources in the media server 200, as well as provide basic user interface features. Specifically, the operating system 210 controls the allocation and usage of the memory 202, the processing time of the processor 206 dedicated to various applications being executed by the processor 206, and the peripheral devices, as well as performing other functionality. In this manner, the operating system 210 serves as the foundation on which applications, such as the media content distribution function 212, depend as is generally known by those with ordinary skill in the art.

The memory 202 may store a media content distribution function 212. In one embodiment, the media content distribution function 212 is embodied as one or more computer programs (e.g., one or more software applications including compilations of executable code). The media content distribution function 212 may be configured to receive a media content request from the venue manager, the media content request including the identity of media content to be broadcast within the geographic coverage area associated with the venue. The request may instruct the media server 200 to include the identified media content in a content feed sent to the wireless TV transmitter 160 for broadcast in the geographic coverage area associated with the venue.

The media content request may include the identification of one or more media content items. In an embodiment where the content feed is a multiplex of media content streams, the media content request may include only the identity of the newly selected media content (as well as the media content it will replace if the newly selected media content is replacing an existing stream of media content). In another embodiment where the content feed is a multiplex of media content streams, the media content request may include the identity of all of the items of media content, including the newly selected media content.

The media content distribution function 212 may be configured to assemble the content feed in response to the media content request. The media server may configure the format (e.g., ATSC) and/or the multiplex (e.g., via multiplexer 216) of the one or more media streams into a multiplexed set of streams available to the wireless TV transmitter 160.

The media content distribution function 212 may obtain the media content from one or more sources. For example, one or more items of media content may be stored in a database 218 of the media server 200. The database 218 may store remote or local media content (e.g., the local content being stored in the database 218 in advance of a media content request). The database 118 may additionally or alternatively store a listing (including the identity, location, availability, cost, duration, etc.) of media content that the media content distribution function may use to retrieve the media content.

In another example, the media content distribution function may receive one or more items of media content with the media content request (e.g., the local content may be included, or the media content management function 114 may stream the content to the media server 200). In another example, the media content distribution function may request and receive one or more items of media content from a remote content source 150. The remote content source 150 may be, for example, a network provider or external database of media content. In another example, the media content distribution function may request and receive one or more items of media content from an over-the-air receiver and video re-encoder 190.

The over-the-air receiver and video re-encoder 190 may capture television content from the remote source for re-transmission by the system (e.g., a re-broadcast of an over-the-air broadcast that is received by the system without significant delay or alteration). In one embodiment, over-the-air receiver and video re-encoder 190 includes one or more broadcast tuners, such as a digital TV tuner, an FM radio tuner, an AM radio tuner, a digital radio tuner, etc. The media content request sent from the media content distribution function may include an instruction to tune to a specific channel for reception. The over-the-air receiver and video re-encoder 190 may provide the ability to supplement the broadcast coverage of television content broadcast from a high-power transmitter to a location that would otherwise have poor or inadequate reception. The local over-the-air receiver and re-encoder 190 may be located at the venue or in a geographic coverage area suitable for receiving the over-the-air broadcast.

The media content distribution function 212 may be configured to send the identified media content in a content feed to the wireless TV transmitter for broadcast within the geographic coverage area associated with the venue. As described above, the content feed may be a multiplex of media content streams, each media content stream obtained from a respective source of media content.

Exemplary embodiments showing the operation of the media content distribution function 212 are described in more detail below.

The media server 200 may have one or more communications interfaces 220. The communications interfaces 220 may include for example, a modem and/or a network interface card. The communications interfaces 220 may enable the media server 200 to send and receive data signals, voice signals, video signals, and the like to and from the venue manager 102, spectrum manager 170, remote content source 150, and/or venue transmitter 160.

With continued reference to FIG. 1, the wireless TV transmitter is shown at 160. The wireless TV transmitter 160 may be embodied as one or more micro TV transmitters. As compared with high-power, high-site, transmitters, micro TV transmitters are low antenna height, low-power transmitters having respective predetermined broadcast areas (e.g., a broadcast area within the geographic coverage area associated with a venue). The use of micro TV transmitter allows for the media content to be locally broadcast, the content having context to the specific localized broadcast location.

The wireless TV transmitter 160 may receive the content feed from the media server (e.g., via IP) and may broadcast the content using standard broadcast protocol (e.g. ATSC mobile). The content feed may be locally broadcast over licensed or unlicensed spectrum (e.g., over TV white space (TVWS)). The elimination of analog television (TV) broadcasts in favor of digital TV broadcasts has freed spectrum for use by radio systems to offer various services, such as TV and radio broadcast, and Internet access. For example, in the U.S., the Federal Communications Commission (FCC) has eliminated analog television (TV) broadcasts in favor of digital TV broadcasts. TV stations now broadcast using digital signals using UHF broadcast bands and VHF broadcast bands in the frequency range of 54 MHz to 698 MHz. Digital TV broadcasts may still be broadcast by a broadcaster in a manner similar to that by which analog TV broadcasts were broadcast. This model permits the broadcast of a single or multiple content streams over a given channel. In the present disclosure the term “channel” encompasses a broadcast band (e.g., a UHF TV band, a VHF TV band, a FM radio band, an AM radio band, etc.), as well as one or more sub-channels included as part of a multiplex associated with the broadcast band.

The number of unique deliverable content streams is partially dependent on the number of licensed and/or unlicensed RF channels in which the TV transmitter can broadcast. High power TV stations use licensed 6 MHz channels authorized by the FCC. However, micro TV transmitters can use licensed or unlicensed TVWS and the availability of spectrum may vary by location or time of day. For example, if two 6 MHz channels of RF spectrum are available in a particular location and the TV transmitter is capable of multiplexing about 16 or more media streams within each 6 MHz RF channel, perhaps about 32 or more media streams could be broadcast within a given location. In some embodiments, the multiplexed media streams may be integrated having reduced content or thinning streams in response to an abundance of requests, allowing the addition of additional streams.

The wireless TV transmitter 160 may communicate with a spectrum manager 170 to acquire an appropriate or adequate amount of usable spectrum available to service the system for transmission of the content over the licensed or unlicensed spectrum, and the wireless TV transmitter 160 may broadcast the content to the one or more wireless electronic devices 300a-300n over the licensed or unlicensed spectrum. In some embodiments, the spectrum manager 170 may communicate with the venue manager 102, the media server 200, and/or the one or more wireless electronic devices to provide information regarding the broadcast channel(s). The media content management function 114 of the venue manager 102 may use such information in analyzing the identification of selected media content, and/or in communications with the one or more wireless electronic devices 300a-300n. The media content distribution function 212 of the media server 200 may use such information in multiplexing the media content. The one or more wireless electronic devices 300a-300n may use such information to tune to receive the content from the wireless TV transmitter.

As shown in FIG. 1, one or more wireless electronic devices 300a-300n may be used in connection with the media content distribution system 100. With additional reference to FIG. 3, an exemplary wireless electronic device is shown at 300. Exemplary wireless electronic devices include personal portable devices such as, for example, a laptop computer, smart phone, tablet, media player, gaming device, personal digital assistant (PDA), electronic book reader, etc. Other examples of wireless electronic devices include a device integrated or installed in a vehicle (e.g., a digital television), or a standalone device.

As discussed in more detail below, the wireless electronic device 300 may be configured to communicate with one or more components of the media content distribution system 100, including the venue manager 102, the media server 200, the TV transmitter 160, and/or the spectrum manager 170 (e.g., through a ‘back channel’ such as Wi-Fi, cellular interface such as 4G, etc.). The wireless electronic device 300 may alternatively or additionally be configured to receive a digital broadcast from the wireless TV transmitter (e.g., using ATSC TV and/or ATSC Mobile TV standards). Such features allow for the wireless electronic device 300 to receive localized broadcast of media content, and may allow for influence/control over the selection of the media content.

The wireless electronic device 300 may include communications circuitry 302. In the illustrated exemplary embodiment, as part of the communications circuitry 302, the wireless electronic device 300 includes a radio circuit 304 and an antenna assembly 306. The communications circuitry 302 may be used to carry out various wireless communications functions, including receiving a digital broadcast and communicating with one or more components of the media content distribution system 100.

The illustrated radio circuitry 304 and antenna assembly 306 represents one or more than one radio transceiver to enable the wireless electronic device 300 to be able to communicate and receive signals over various types of network connections and/or protocols. In one embodiment, the communications circuitry 302 includes one or more broadcast tuners, such as a digital TV tuner, an FM radio tuner, an AM radio tuner, a digital radio tuner, etc, as well as a transceiver capable of establishing backchannel communication with the system, such as a cellular communications transceiver, or a packet-switched communications transceiver (e.g., Wi-Fi or WiMAX).

The wireless electronic device 300 may include a memory 308 for storing data, logic routine instructions, computer programs, files, operating system instructions, and the like. The memory 308 is considered a non-transitory computer readable medium and may comprise several devices, including volatile and non-volatile memory components. Accordingly, the memory 308 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the wireless electronic device 300 may be controlled by a control circuit 310. The control circuit 310 may include one or more processors 312 used to execute instructions that carry out a specified logic routine(s). The control circuit 310 and the components of the memory 308 may be coupled using a local interface 314. The local interface 314 may be, for example, a data bus with accompanying control bus, a network, or other subsystem.

The memory 308 may store an operating system 316 that is executed by the processor 312 to control the allocation and usage of resources in the wireless electronic device 300, as well as provide basic user interface features. Specifically, the operating system 316 controls the allocation and usage of the memory 308, the processing time of the processor 312 dedicated to various applications being executed by the processor 312, and the peripheral devices, as well as performing other functionality. In this manner, the operating system 316 serves as the foundation on which applications, such as the broadcast request function 318, depend as is generally known by those with ordinary skill in the art.

The memory 308 may store a broadcast request function 318. The broadcast request function 318 may be embodied as one or more computer programs (e.g., one or more software applications including compilations of executable code). The broadcast request function 318 may be configured to send a broadcast request to the venue manager 102. In some embodiments, the broadcast request may include the identity of requested media content for broadcast within the geographic coverage area associated with the venue. The broadcast request may additionally include information regarding the wireless electronic device making the request (e.g., identification of the wireless electronic device, access/authentication information, etc.). In other embodiments, the broadcast request may include a request for a channel list of media content presently being broadcast within the geographic coverage area associated with the venue.

The media content management function 114 of the venue manager 102 may be configured to receive the broadcast request from the wireless electronic device. As discussed above, in embodiments where the broadcast request may include the identity of requested media content, the media content management function 114 of the venue manager 102 may identify the media content based on the broadcast request and may also analyze the broadcast request. In embodiments where the broadcast request includes a request for a channel list, the media content management function 114 of the venue manager may provide the wireless electronic device with such information.

The broadcast request function 318 may further be configured to receive a broadcast response from the venue manager 102. The broadcast response may include information regarding the result of the inquiry (e.g., an acknowledgement that the request has been received, the identity of the channel on which the requested content is broadcast, an indication that the request has been denied, a channel list of media content presently being broadcast within the geographic coverage area associated with the venue, etc.).

Exemplary embodiments showing the operation of the broadcast request function 318 are described in more detail below.

The electronic device 300 may include a display 324. The display 324 displays information to a user such as operating state, time, telephone numbers, contact information, various menus, etc., that enable the user to utilize the various features of the electronic device 300. The display 324 also may be used to visually display content received by the electronic device 300. The display 324 may be used to present images, video and other graphics to the user, such as photographs, television content, mobile television content, Internet pages, and video associated with games. The display 324 may be coupled to the control circuit 310 by a video processing circuit 326 that converts video data to a video signal used to drive the display 324. The video processing circuit 326 may include any appropriate buffers, decoders, video data processors and so forth. The video data may be derived from an incoming video data stream that is received by the communications circuitry 302.

The wireless electronic device 300 may include a sound signal processing circuit 328 for processing audio signals received from the communications circuitry 302. Coupled to the sound signal processing circuit 328 is a speaker 330 that enables a user to listen to audio data received by the wireless electronic device 300. The audio data may include, for example, received audio data such as in the form of streaming audio data. The sound signal processing circuit 328 may include any appropriate buffers, decoders, encoders, amplifiers and so forth. A microphone 320 also may be operatively coupled to the control circuit 310 via the sound signal processing circuit 328.

The wireless radio device 300 may have various video and input/output (I/O) interfaces 332. The (I/O) interfaces 332 may be used to operatively couple the wireless radio device 300 to various peripherals (not shown), such as a display, a keyboard, a mouse, other input devices, a microphone, a camera, a scanner, a printer, a speaker, a power supply, and so forth.

The following description provides exemplary embodiments by which localized media content distribution may be executed. These exemplary embodiments may be carried out, in part, by executing an embodiment of the media content management function 114 of the venue manager 102, an embodiment of the media content distribution function 212 of the media server 200, and/or an embodiment of the broadcast request function 318 of the wireless electronic device 300. Therefore, the following exemplary embodiments represent one or more methods that may be carried out by the venue manager 102, one or more methods that may be carried out by the media server 200, and one or more methods that may be carried out by the wireless electronic device 300. Although the exemplary embodiments show specific orders of executing functional logic blocks, the order of executing the blocks may be changed relative to the order shown. Also, two or more blocks shown in succession may be executed concurrently or with partial concurrence. Furthermore, one or more of the functional logic blocks may be omitted.

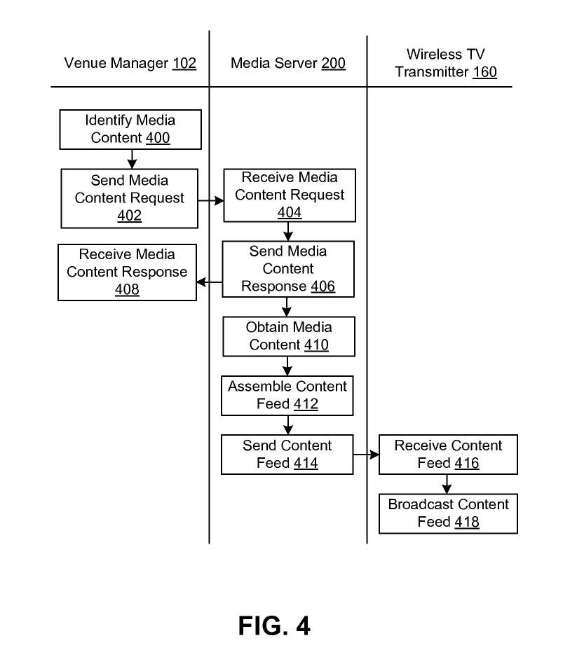

FIG. 4 shows an exemplary embodiment of localized media content distribution. In accordance with the exemplary embodiment, the venue manager 102 may control the configuration of the media content provided by the media server and broadcast by the TV transmitter, absent input from the one or more wireless electronic devices. Such an embodiment may only allow users of the wireless electronic devices to view pre-configured channels (that are preconfigured at the discretion of the venue manager), without the ability to further influence what is available. For example, if the broadcasting system is using one 6 MHz channel that contains 16 channels within a multiplex, the user of the wireless electronic device has the ability to select content for any one of the 16 available channels.

The broadcast management process may commence at step 400 where the media content management function 114 of the venue manager 102 identifies media content to be broadcast within the geographic coverage area associated with the venue by the wireless TV transmitter 160. The media content management function 114 may identify the media content, absent input from the one or more wireless electronic devices. For example, a user of the venue manager 102 may select one or more media content items to broadcast via the content feed. The selected media content may be any content selected from one or more sources (e.g., content stored at the media server, content from the remote content source, local broadcast to be captured by the local (over-the-air) receiver and video re-encoder, local content stored at the venue manager or uploaded live from the venue, etc.). The selected media content may be selected to replace an existing stream of multimedia content that is presently included in the content feed.

At step 402, the media content management function 114 of the venue manager 102 may send a media content request to the media server 200. The media content request may include the identity of the media content, and may additionally include information such as the location of the media content. In some embodiments (e.g., where the identified content is to be included in a multiplex), the media content request may include a listing of all the media content items included in the multiplex, including the identity of the identified media content. In some embodiments where the selected media content is selected to replace a stream of multimedia content that is included in the content stream, the media content request may further include the identity of the content to be replaced. At step 404, the media content request may be received at the media server 200.

At step 406, the media content distribution function 212 of the media server 200 may send a media content response to the venue manager. The media content response may include an acknowledgement that the request has been received and/or information regarding the channel on which the requested content is broadcast (although not specifically shown, the media server 200 may receive information from the wireless TV transmitter regarding the broadcast spectrum, and/or the media server 200 may be in communication with the spectrum manager). At step 408, the media content response may be received at the venue manager 102.

At step 410, the media content distribution function 212 of the media server 200 may obtain the identified media content. The media content distribution function 212 may obtain the media content from one or more sources (e.g., from the database 218 of the media server 200, from the venue manager 102, from the local (over-the-air) receiver and video re-encoder, and/or from the remote content source 150).

At step 412, the media content distribution function 212 of the media server 200 may assemble the content feed. The media content distribution function 212 of the media server may 200 configure the format (e.g., ATSC) and/or the multiplex (e.g., via multiplexer 216) the one or more media streams into a multiplexed set of streams.

At step 414, the media content distribution function 212 of the media server 200 may send the content feed to the wireless TV transmitter 160. At step 416, the media content response may be received at the wireless TV transmitter.

At step 418, the wireless TV transmitter may broadcast the content feed including the identified media content. The content feed may be broadcast over licensed or unlicensed spectrum. Although not specifically shown, the wireless TV transmitter may be in communication with the spectrum manager and may identify the spectrum. Alternatively, the media server may have communicated with the spectrum manager to identify the spectrum, the media content distribution function 212 of the media server 200 in turn providing the identity of the spectrum to the wireless TV transmitter (e.g., as a part of the content feed sent from the media server 200 to the wireless TV transmitter). Furthermore, although not specifically shown, the venue manager 102 may receive information regarding spectrum over which the content feed is broadcast from the spectrum manager 170 or from the wireless TV transmitter 160.

Some implementations of the wireless electronic device 300 are capable of discovering available digital broadcasts in a location by scanning the spectrum for available broadcasts and identifying the available broadcasts and associated channel numbers. Other implementations of the wireless electronic device 300 communicate with the venue manager to discover the available broadcasts. For example, the broadcast request function 318 of the wireless electronic device 300 may send a request for a list of channels to the venue manager 102. In response, the media content management function 114 of the venue manager 102 may send a list of channels to the wireless electronic device 300. In other examples, this communication may be performed between the wireless electronic device 300 and one of the wireless TV transmitter 160, the media server 300, or the spectrum manager 170.

As an example, the embodiment of localized media content distribution discussed in relation to FIG. 4 may be employed in the context of the broadcast of an auto race. Several cars in the race may include an in-car camera, thereby providing respective in-car views. The venue manager 102 may identify these streams as streams to be broadcast to wireless electronic devices 300a-300n located within the racetrack, may request that the media server 200 multiplex the streams for broadcast. The feed from the in-car cameras may be uploaded live (e.g., via IP) to the media server 200, multiplexed, and sent to the wireless TV transmitter 160. The wireless TV transmitter 160 may broadcast the multiplex over available spectrum. Wireless electronic devices 300a-300n within the racetrack may scan for and receive the broadcast. Other wireless electronic devices 300a-300n within the racetrack may request and receive a list of the broadcasts and associated channels from the wireless TV transmitter 160, venue manager 102, and/or media server 200.

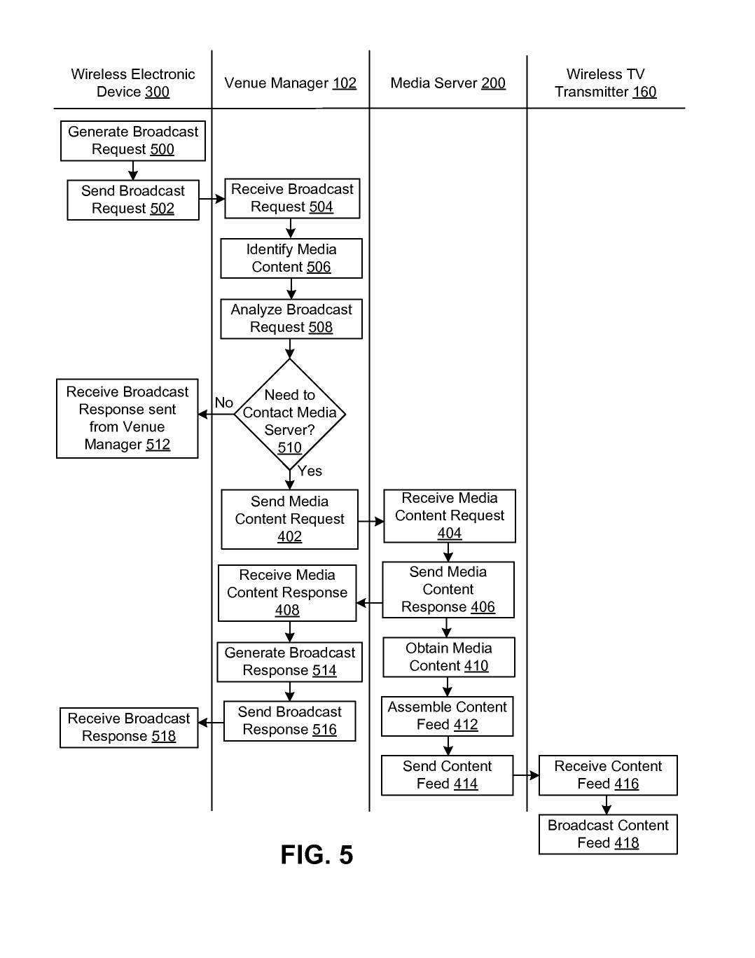

FIG. 5 shows another exemplary embodiment of localized media content distribution. In accordance with the exemplary embodiment, the content provided by the media server 200 and broadcast by the wireless TV transmitter 160 may be based at least in part on selections and/or preferences provided by one or more wireless electronic devices. In an example, selections and/or preferences of a user of a wireless electronic device may be used at the venue manager 102 to influence and/or dictate the selection of media content for broadcast within the venue.

The broadcast management process may commence at step 500 where the broadcast request function 318 of the wireless electronic device 300 generates a broadcast request. The broadcast request may include the identity of the requested media content for broadcast within the geographic coverage area associated with the venue. The broadcast request may additionally include information regarding the wireless electronic device making the request (e.g., identification of the wireless electronic device, access/authentication information, etc.).

At step 502, the broadcast request is sent to the venue manager 102. The broadcast request may be sent through a ‘back channel’ such as Wi-Fi, cellular interface such as 4G, etc.). At step 504, the broadcast request may be received by the media content management function 114 of the venue manager 102.

At step 506, the media content management function 114 of the venue manager 102 identifies media content to be broadcast within the geographic coverage area associated with the venue by the wireless TV transmitter. Identification of media content may be based on the media content identified in the broadcast request.

At step 508, the media content management function 114 of the venue manager analyzes the broadcast request (including the identity of the media content). In one embodiment, the media content management function 114 may analyze the broadcast request received from a wireless electronic device 300a-300n in view of one or more criteria set at the venue manager 102. The criteria set at the venue manager may include access/authorization information (e.g., pertaining to the identity of the wireless electronic device, the allotted duration that a given wireless electronic device is permitted to use the system, etc.), as well as information pertaining to the type of content (e.g., genre, duration, cost, etc.) and the overall number of channels that may be broadcast. The criteria set at the venue manager may additionally or alternatively include preference information from the media server or remote content source (e.g. network provider).

In another embodiment, the analysis performed by the media content management function 114 may include comparison of the identified media content to the media content that is presently being broadcast (e.g., to determine whether the identified media content is presently being broadcast).

In another embodiment, the analysis performed by the media content management function 114 may include a determination of whether a channel is available for broadcasting the identified content. Where all available channels are occupied, a determination may be made whether a new item of media content should replace media content that is presently being broadcast. This determination may be made based on an analysis of the identified media content selection in view of selections from other wireless electronic devices 300a-300n, and/or in view of one or more criteria set at the venue manager 102.

At step 510, the media content management function may determine (e.g., in view of the analysis performed in step 508) whether it is necessary to contact the media server 200. In some instances, the media content to be broadcast does not change in response to the broadcast request. For example, the identified media content may be unavailable, the identified media content may already be a part of the content feed, or a channel is unavailable for broadcast. In such instance, the wireless electronic device may receive a broadcast response from the venue manager in this regard (step 512).

If the media content management function determines that it is necessary to contact the media server, the exemplary embodiment may proceed in accordance with steps 402-418 as discussed above in relation to FIG. 4. For the sake of brevity, such steps are referred to above.

In addition to the method as set forth in steps 402-418, the media content management function may generate and send a broadcast response (steps 514 and 516) to the wireless electronic device in response to receiving a media content response at step 408. The broadcast response may include information such as a confirmation that the media content is to be broadcast, the identity of the channel on which the media content is broadcast, and/or the identity of any other channels of media content that is being broadcast. The broadcast response may be received by the wireless electronic device 300 at step 518.

As an example, the embodiment of localized media content distribution discussed in relation to FIG. 5 may be employed in the context where patron at a sports bar desires to watch a broadcast of his favorite football team. The wireless electronic device sends a broadcast request to the venue manager, the broadcast request including the identity of the requested media content. If the request matches currently available content (i.e., content that is presently being broadcast), the venue manager may provide the wireless electronic device with the channel on which the content is being broadcast. The media content management function 114 of the venue manager may tally the request and use it as crowd-sourced bias to keep this content stream active.

If the broadcast request does not match currently available content (i.e., content that is presently being broadcast) and mobile channel capacity is available within the channel multiplex, the venue manager 102 may send a media content request to the media server identifying such content, and the media server 200 may integrate the media stream into the over-the-air TV channel multiplex. The venue manager 102, the wireless TV transmitter 160, the media server 200, or the spectrum manager 170 may provide the wireless electronic device with the channel on which the content is being broadcast. The media content management function 114 of the venue manager may tally the request and use it as crowd-sourced bias to keep this content stream active.

If the broadcast request does not match currently available content (i.e., content that is presently being broadcast) and mobile channel capacity is not available, venue manager may compare this request with the bias of active content streams and with other pending requests. If enough bias or votes do not exist (i.e. the demand for this particular media stream does not exceed the demand for an active stream) the venue manager 102 may inform the wireless electronic device of the patron that its request is presently unavailable. The venue manager 102 may offer available content to the wireless electronic device that is similar to that which was requested (e.g., same or similar genre of programming). If, however, enough bias or votes exist (i.e. the demand for this particular media stream exceeds the demand for an active stream), the venue manager 102 may send a media content request to the media server 200 identifying such content, and the media server 200 may integrate the media stream into the over-the-air TV channel multiplex. The venue manager 102, the wireless TV transmitter 160, the media server 200, or the spectrum management apparatus 170 may provide the wireless electronic device with the channel on which the content is being broadcast.

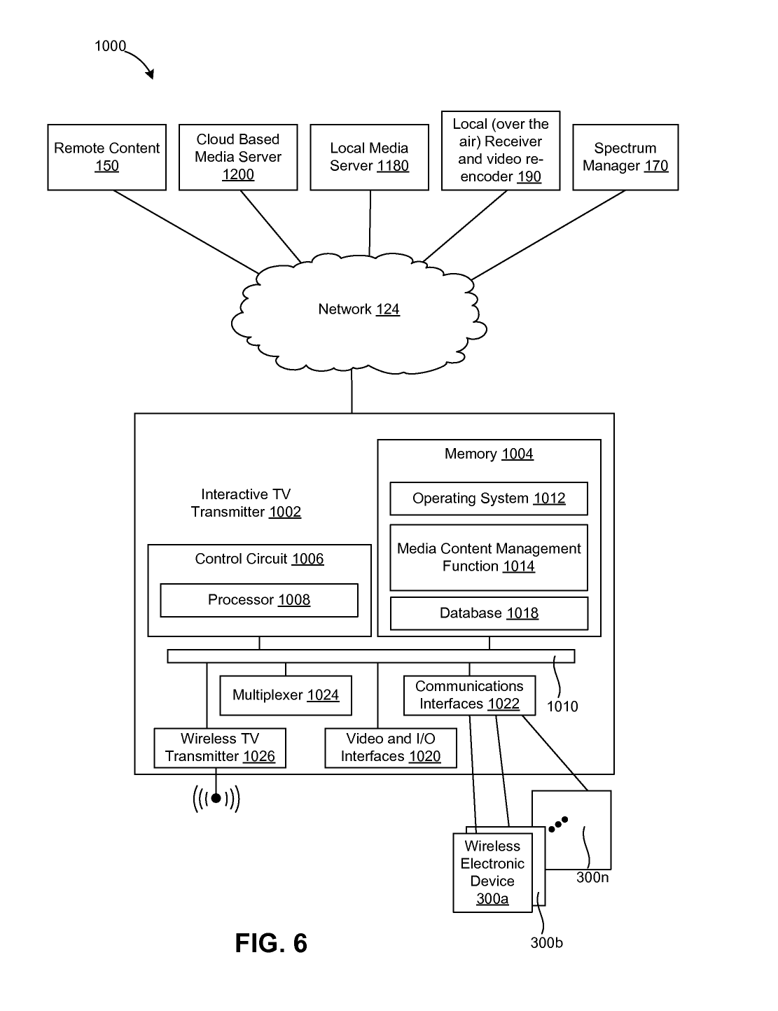

FIG. 6 schematically shows a second exemplary embodiment of the multicast media distribution system 1000. In accordance with this exemplary embodiment, the wireless TV transmitter is embodied as an interactive TV transmitter 1002. Accordingly, the TV transmitter may be configured to perform various functions as are performed by the venue manager 102, media server 200, and wireless TV transmitter 160 as set forth above in the first exemplary embodiment. For example, the interactive TV transmitter 1002 may interact with the one or more wireless electronic devices, collect content and user preferences from various sources, multiplex the content, and/or broadcast the multiplexed content within the geographic coverage area associated with the venue.

The exemplary media content distribution system 1000 may include the interactive TV transmitter 1002 and one or more sources of media content, such as a cloud based media server 1200, a local media server 1180, a local (over the air) receiver and video re-encoder 190, and/or a remote content source 150. The exemplary media content distribution system 1000 may further include a spectrum manager 170. The media distribution system 100 may be configured to broadcast media content to one or more wireless electronic devices 300a-300n.

The remote content source 150, spectrum database 170, local (over the air) receiver and video re-encoder 190, and wireless electronic devices 300a-300n set forth in this exemplary embodiment may be the same as those that are implemented in the first exemplary embodiment discussed above. Accordingly, such components are similarly numbered as in the first exemplary embodiment, and for the sake of brevity, the descriptions of such components are referred to above.

The interactive TV transmitter 1002 may be configured to execute various functions for managing the specific media content that is broadcast to the one or more wireless electronic devices 300a-300n. As discussed in more detail below, the interactive TV transmitter 1002 may be configured to communicate with the cloud based media server 1200, the remote content source 150, the local media server 1180, the local (over the air) receiver and video re-encoder 190, and/or the spectrum manager 170. The interactive TV transmitter 1002 may additionally be configured to communicate with the one or more wireless electronic devices 300a-300n. The interactive TV transmitter 1002 may be configured to identify media content to be broadcast within the geographic coverage area associated with a venue by the wireless TV transmitter 160, multiplex the identified media content with other media content, and broadcast the multiplex including the identified media content with the wireless TV transmitter in the geographic coverage area associated with the venue. Such features allow for control over the localized broadcast of media content.

The interactive TV transmitter 1002 may include a memory 1004 for storing data, logic routine instructions, computer programs, files, operating system instructions, and the like. The memory 1004 is considered a non-transitory computer readable medium and may comprise several devices, including volatile and non-volatile memory components. Accordingly, the memory 1004 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the interactive TV transmitter 1002 may be controlled by a control circuit 1006. The control circuit 1006 may include one or more processors 1008 used to execute instructions that carry out a specified logic routine(s). The control circuit 1006 and the components of the memory 1004 may be coupled using a local interface 1010. The local interface 1010 may be, for example, a data bus with accompanying control bus, a network, or other subsystem.

The memory 1004 may store an operating system 1012 that is executed by the processor 1008 to control the allocation and usage of resources in the server 1002, as well as provide basic user interface features. Specifically, the operating system 1012 controls the allocation and usage of the memory 1004, the processing time of the processor 1008 dedicated to various applications being executed by the processor 1008, and the peripheral devices, as well as performing other functionality. In this manner, the operating system 1012 serves as the foundation on which applications, such as the media content management function 1014, depend as is generally known by those with ordinary skill in the art. The operating system 1012 also may control much of the user interface environment presented to a user, such as features of the overall graphical user interface (GUI) for the system.

The memory 1004 may store a media content management function 1014. In one embodiment, the media content management function 1014 is embodied as one or more computer programs (e.g., one or more software applications including compilations of executable code). The media content management function 1014 may be configured to identify media content to be broadcast by the wireless TV transmitter 1026 within the geographic coverage area associated with the venue. This identification may be made based on selections and/or preferences set at the interactive TV transmitter 1002 and/or selections and/or preferences received from the one or more wireless electronic devices 300a-300n located in the geographic coverage area associated with the venue. For example, the media content management function 1014 may identify media content based on a user selection at the interactive TV transmitter. In another example, the media content management function 1014 may identify media content based on a broadcast request received from a wireless electronic device 300a-300n within the geographic coverage area associated with the venue.

The media content management function 114 may be configured to analyze the identification of media content made at the interactive TV transmitter 1002 and/or the broadcast request received from a wireless electronic device. In one embodiment, the media content management function 1014 may analyze a selection made at the interactive TV transmitter 1002 and/or the broadcast request received from a wireless electronic device 300a-300n in view of one or more criteria set at the interactive TV transmitter 1002. The criteria set at the interactive TV transmitter may include access/authorization information (e.g., pertaining to the identity of the wireless electronic device, the allotted duration that a given wireless electronic device is permitted to use the system, etc.), as well as information pertaining to the type of content (e.g., genre, duration, cost, etc.) and the overall number of channels that may be broadcast. The criteria set at the interactive TV transmitter may additionally or alternatively include preference information from one or more of the sources of content. This information may be used to tailor the access and/or type of content broadcast via the media content distribution system 1000.

In another embodiment, the analysis performed by the media content management function 1014 may include comparison of the identified media content to the media content that is presently being broadcast. For example, if the media content management function 1014 determines that the identified media content is presently being broadcast, the media content management function 1014 may send the identity of the channel to the wireless electronic device in lieu of altering the multiplex.

In another embodiment, the analysis performed by the media content management function 1014 may include a determination of whether a channel is available for broadcasting the identified content. If the number of wireless electronic devices is equal to, or less than the number of channels that are provided, each wireless electronic device in a venue can select or reserve its own channel with no contention, via the mobile application (described above). It is possible that the number of wireless electronic devices registered or capable of interacting with the TV transmitter is greater than the number of available channels. In an example where X channels are available, if more than X viewers exist within a venue at a given time, there is a possibility that each may view desired content due to synergy in viewing choices. However, as the number of viewers increase, the probability increases that viewers may want to access content that is available, but not currently streamed.

Accordingly, where all available channels are occupied, a determination may be made whether a new item of media content should replace media content that is presently being broadcast. In an embodiment where the media content is set based on selection at the interactive TV transmitter (absent any input from the one or more wireless electronic devices 300a-300n), this determination may be made based solely on the instruction of the user at the interactive TV transmitter to replace an existing item of media content with a new item of media content. In another embodiment where one or more selections may be provided by the one or more wireless electronic devices 300a-300n, the one or more selections may be weighed against one another for determining the specific item(s) of media content to be broadcast within the geographic coverage area. The media content management function 1014 may identify the media content based on factors such as the number of requests for a given content, the frequency of the requests for the given content, the cost of a given content, and/or the duration of a given content. Also, the weight of a given selection may vary depending on the status of the device that has requested the selection. For example, certain wireless electronic devices may be given a prioritized status (e.g., based on membership, payment, etc.) that may influence the identification of the media content. Furthermore, the one or more selections may be weighed against one another, and in view of one or more criteria set at the interactive TV transmitter 1002 as discussed above.

The media content management function 1014 may be configured to send a media content request to the cloud based media server 1200, the remote content source 150, the local media server 1180, and/or the local (over the air) receiver and video re-encoder 190. The media content request may include the identity of the media content. In the case of the local (over the air) receiver and video re-encoder 190, the media content request may include an instruction to tune to a given broadcast in accordance with the identified media content. Additionally, the media content management function 1014 may be configured to receive a media content response. The media content response may include the requested content.

The media content management function 1014 may be configured to multiplex the media content piped from the cloud based media server 1200, the remote content source 150, the local media server 1180, and/or the local (over the air) receiver and video re-encoder 190 to the interactive TV transmitter 1002 via the n-channel program multiplexer 1024. The media content management function 1014 may further be configured to broadcast the multiplexed stream as an over-the-air TV channel multiplex. The multiplexed media content may be broadcast within the geographic coverage area associated with the venue over licensed or unlicensed spectrum.

The media content management function 1014 may be configured to receive a broadcast request from one or more wireless electronic devices. The broadcast request may include the identity of the requested media content for broadcast within the geographic coverage area associated with the venue. The broadcast request may additionally include information regarding the wireless electronic device making the request (e.g., identification of the wireless electronic device, access/authentication information, etc.). In other embodiments, the broadcast request may include a request for a channel list of media content presently being broadcast within the geographic coverage area associated with the venue.

The media content management function 1014 may be configured to send a broadcast response to one or more wireless electronic devices 300. The broadcast response may include information regarding the result of the inquiry (e.g., an acknowledgement that the request has been received, the identity of the channel on which the requested content is broadcast, an indication that the request has been denied, a channel list of media content presently being broadcast within the geographic coverage area associated with the venue, etc.).

Accordingly, the media content management function 1014 may control and/or influence the content that is broadcast from the media server to the one or more wireless electronic devices based on one or more input preferences/criteria from the one or more wireless electronic devices and/or the venue manager itself. Exemplary embodiments showing the operation of the media content management function 1014 are described in more detail below.

The interactive TV transmitter 1002 may include a multiplexer 1024 and a wireless TV transmitter 1026. The multiplexer 1024 may be a n-channel program multiplexer that may aggregate various content streams from different sources into a single channel multiplex to be broadcast. The wireless TV transmitter 1026 may modulate the single channel multiplex for over the air broadcast. The wireless TV transmitter 1026 may be embodied as one or more micro TV transmitters having a predetermined broadcast area (e.g., a broadcast area within the geographic coverage area associated with a venue). The wireless TV transmitter 1026 may broadcast the content using standard broadcast protocol (e.g. ATSC mobile) over licensed or unlicensed spectrum. Accordingly, the interactive TV transmitter may be configured to accept media streams (e.g., in MPEG format) encapsulated within an IP transport protocol and rebroadcast them in a single channel multiplex containing an aggregate of media streams that can be received and demodulated by the wireless electronic device(s).

The interactive TV transmitter 1002 may communicate with the spectrum manager 170 to coordinate transmission of the content over the licensed or unlicensed spectrum, and may broadcast the content to the one or more wireless electronic device over such spectrum. The media content management function 1014 of the interactive TV transmitter 1002 may be configured to perform such functionality.

The memory 1004 may store a database 1018. The database 1018 may store information used by the broadcast channel determination function 1014. For example, the database 1018 may store a history of media content selections and requests from the user of the venue manager and/or users of the one or more wireless electronic devices. The database 1018 may additionally or alternatively store criteria set at the interactive TV transmitter and/or received from one or more of the content sources, such as access/authorization information (e.g., pertaining to the identity of the wireless electronic device, the allotted duration that a given wireless electronic device is permitted to use the system, etc.), as well as information pertaining to the type of content (e.g., genre, duration, cost, etc.) and the overall number of channels that may be broadcast. The database 1018 may additionally or alternatively store a listing (including the identity, location, availability, cost, duration, etc.) of available content that may be used in selecting a media content. The database 1018 may additionally or alternatively store local content.

The interactive TV transmitter 1002 may have various video and input/output (I/O) interfaces 1020 as well as one or more communications interfaces 1022. The I/O interfaces 1020 may be used to operatively couple the interactive TV transmitter 1002 to various peripherals (not shown), such as a display, a keyboard, a mouse, video camera, and/or one or more other suitable input devices. The communications interfaces 1022 may include for example, a modem and/or a network interface card. The communications interfaces 1022 may enable the interactive TV transmitter 1002 to send and receive data signals, voice signals, video signals, and the like to and from the media server 1200, the one or more wireless electronic devices 300a-300n, the spectrum manager 170, local media server 1180 via an external network 124, local (over the air) receiver and video re-encoder 190, spectrum manager 170, and remote content source 150 (e.g., the Internet, a wide area network (WAN), a local area network (LAN), direct data link, or similar systems).

The local media server 1180 and the cloud based media server 1200 may provide media content accessible by the interactive TV transmitter. For example, the cloud based media server 1200 may be a remote database containing content that can be accessed over the internet. The local media server 1180 may be a database containing local content. The local media server 1180 may be managed and/or provided by the venue operator.

The following description provides exemplary embodiments by which localized media content distribution may be executed. These exemplary embodiments may be carried out, in part, by executing an embodiment of the media content management function 1014 of the interactive TV transmitter and/or an embodiment of the broadcast request function 318 of the wireless electronic device 300. Therefore, the following exemplary embodiments represent one or more methods that may be carried out by the interactive TV transmitter and one or more methods that may be carried out by the wireless electronic device 300. Although the exemplary embodiments show specific orders of executing functional logic blocks, the order of executing the blocks may be changed relative to the order shown. Also, two or more blocks shown in succession may be executed concurrently or with partial concurrence. Furthermore, one or more of the functional logic blocks may be omitted.

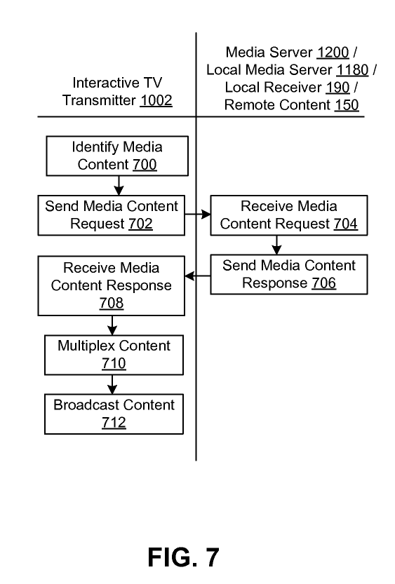

FIG. 7 shows an exemplary embodiment of localized media content distribution. In accordance with the exemplary embodiment, the interactive TV transmitter 1002 may control and broadcast the media content based on a configuration established at the interactive TV transmitter, absent input from the one or more wireless electronic devices 300a-300n.

The broadcast management process may commence at step 700 where the media content management function 1014 of the interactive TV transmitter 1002 identifies media content to be broadcast by the interactive TV transmitter within the geographic coverage area associated with the venue.

At step 702, the media content management function 1014 of the interactive TV transmitter 1002 may send one or more media content requests to one or more content sources. For example, the media content management function 1014 may send a media content request to any of the cloud based media server 1200, the remote content source 150, the local media server 1180, and/or the local (over the air) receiver and video re-encoder 190. In some embodiments, the media content request may include the identity of the requested media content. In other embodiments, the media content request may include an instruction to tune to a given broadcast in accordance with the identified media content. At step 704, the one or more media content requests may be received at the respective sources of media content (e.g., one or more of the cloud based media server 1200, the remote content source 150, the local media server 1180, or the local (over the air) receiver and video re-encoder 190).

At step 706, one or more of the media server, local media server, local receiver, or remote content may send a media content response to the interactive TV transmitter. The content response may include the media content piped from the media content source (e.g., the cloud based media server 1200, the remote content source 150, the local media server 1180, and/or the local (over the air) receiver and video re-encoder 190). At step 708, the media content response may be received by the media content management function 1014 of the venue manager 1002.

At step 710, the media content management function multiplexes the received content piped from the cloud based media server 1200, the remote content source 150, the local media server 1180, and/or the local (over the air) receiver and video re-encoder 190 to the interactive TV transmitter using the multiplexer.

At step 712, the media content management function broadcasts the received content within the geographic coverage area associated with the venue. The content feed may be broadcast over licensed or unlicensed spectrum. Although not specifically shown, the interactive TV transmitter 1002 may be in communication with the spectrum manager 170 and may identify the spectrum over which the multiplex is broadcast.

As discussed above, some implementations of the wireless electronic device 300 are capable of discovering available digital broadcasts in a location by scanning the spectrum for available broadcasts and identifying the available broadcasts and associated channel numbers. Some implementations of the wireless electronic device 300 may communicate with the interactive TV transmitter 1002 to discover the available broadcasts. For example, the broadcast request function 318 of the wireless electronic device 300 may send a request for a list of channels to the interactive TV transmitter 1002. In response, the media content management function 1014 of the interactive TV transmitter 1002 may send a list of channels to the wireless electronic device 300.

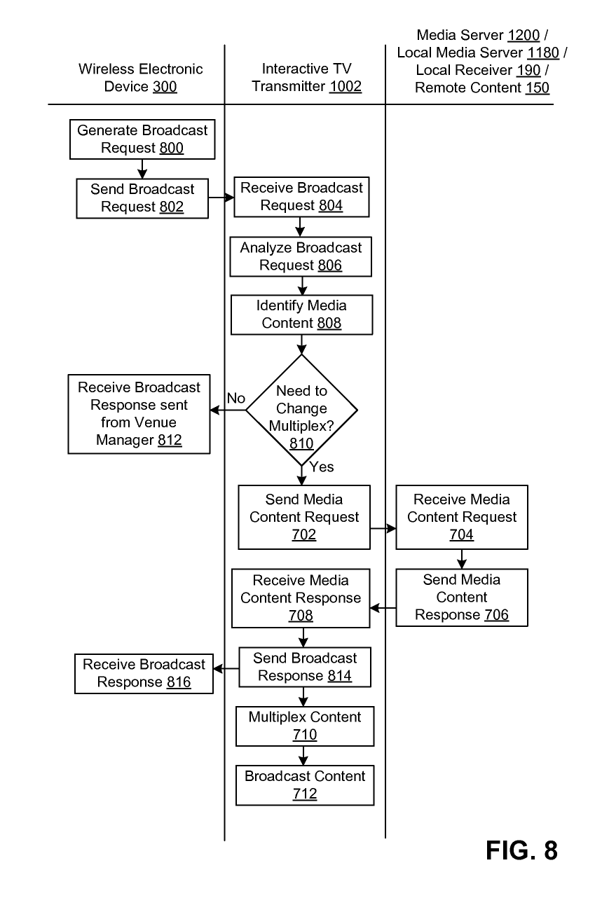

FIG. 8 shows another exemplary embodiment of localized media content distribution. In accordance with the exemplary embodiment, the content broadcast by the interactive TV transmitter may be identified based at least in part on selections and/or preferences provided by one or more wireless electronic devices. In an example, selections and/or preferences of a user of a wireless electronic device may be used at the interactive TV transmitter 1002 to influence and/or dictate the selection of media content for broadcast within the venue.

The broadcast management process may commence at step 800 where the broadcast request function 318 of the wireless electronic device 300 generates a broadcast request. The broadcast request may include the identity of the requested media content for broadcast within the geographic coverage area associated with the venue. The broadcast request may additionally include information regarding the wireless electronic device making the request (e.g., identification of the wireless electronic device, access/authentication information, etc.).

At step 802, the broadcast request is sent to the interactive TV transmitter 1002. The broadcast request may be sent through a ‘back channel’ such as Wi-Fi, cellular interface such as 4G, etc.). At step 804, the broadcast request may be received by the media content management function 1014 of the interactive TV transmitter 102.

At step 806, the media content management function 1014 of the interactive TV transmitter 1002 identifies media content to be broadcast by the interactive TV transmitter within the geographic coverage area associated with the venue. Identification of media content may be based on the media content identified in the broadcast request.

At step 808, the media content management function 1014 of the interactive TV transmitter analyzes the broadcast request (including the identity of the media content). In one embodiment, the media content management function 1014 may analyze the broadcast request received from a wireless electronic device 300a-300n in view of one or more criteria set at the venue manager 102. The criteria set at the interactive TV transmitter may include access/authorization information (e.g., pertaining to the identity of the wireless electronic device, the allotted duration that a given wireless electronic device is permitted to use the system, etc.), as well as information pertaining to the type of content (e.g., genre, duration, cost, etc.) and the overall number of channels that may be broadcast. The criteria set at the interactive TV transmitter may additionally or alternatively include preference information from the media server or remote content source (e.g. network provider).

In another embodiment, the analysis performed by the media content management function 114 may include a comparison of the identified media content to the media content that is presently being broadcast (e.g., to determine whether the identified media content is presently being broadcast).

In another embodiment, the analysis performed by the media content management function 114 may include a determination of whether a channel is available for broadcasting the identified content. Where all available channels are occupied, a determination may be made whether a new item of media content should replace media content that is presently being broadcast. This determination may be made based on an analysis of the identified media content selection in view of selections from other wireless electronic devices 300a-300n, and/or in view of one or more criteria set at the interactive TV transmitter 1002.

At step 810, the media content management function 1014 may determine (e.g., in view of the analysis performed in step 808) whether it is necessary to change the multiplex. In some instances, the media content to be broadcast does not change in response to the broadcast request. For example, the identified media content may be unavailable, the identified media content may already be a part of the content feed, or a channel is unavailable for broadcast. In such instance, the wireless electronic device may receive a broadcast response from the interactive TV transmitter in this regard (step 812).

If the media content management function determines that it is necessary to change the multiplex, the exemplary embodiment may proceed in accordance with steps 702-712 as discussed above in relation to FIG. 4. For the sake of brevity, such steps are referred to above.

In addition to the method as set forth in steps 702-712, the media content management function 1014 may send a broadcast response (step 814) to the wireless electronic device in response to receiving a media content response at step 708. The broadcast response may include information such as a confirmation that the media content is to be broadcast, the identity of the channel on which the media content is broadcast, and/or the identity of any other channels of media content that is being broadcast. The broadcast response may be received by the wireless electronic device 300 at step 716.

### D. CONCLUSION

Although certain embodiments have been shown and described, it is understood that equivalents and modifications falling within the scope of the appended claims will occur to others who are skilled in the art upon the reading and understanding of this specification.

What is claimed is:

1. A venue manager, comprising:
communications circuitry configured to communicate with a media server; and
control circuitry that executes a media content management function configured to control content broadcast by a wireless TV transmitter having a geographic coverage area associated with a venue by:
identifying media content to be broadcast within the geographic coverage area associated with the venue by the wireless TV transmitter; and
sending a media content request to the media server, the media content request comprising the identity of the media content, the request instructing the media server to include the identified media content in a content feed sent to the wireless TV transmitter for broadcast in the geographic coverage area associated with the venue.

2. The venue manager of claim 1, wherein the identified media content replaces media content presently included in the content feed sent to the wireless TV transmitter for broadcast in the geographic coverage area associated with the venue.

3. The venue manager of claim 1, wherein the content feed is a multiplex of media content sent to the wireless TV transmitter for broadcast in the geographic coverage area associated with the venue.

4. The venue manager of claim 1, wherein the media content management function is further configured to analyze the identified media content in view of criteria set at the venue manager and send the media content request as a result of the analysis, the criteria comprising one or more of access or authorization information, information pertaining to a type of permitted content, and a number of available channels.

5. The venue manager of claim 1, wherein the communications circuitry is further configured to communicate with one or more wireless electronic devices located within the geographic coverage area associated with the venue; and
the media content management function is further configured to identify the media content based on a broadcast request received from a wireless electronic device located within the geographic coverage area associated with the venue.

6. The venue manager of claim 5, wherein the media content management function is further configured to analyze the broadcast request including the identity of the media content in view of criteria set at the venue manager and send the media content request as a result of the analysis, the criteria comprising one or more of access or authorization information, information pertaining to a type of permitted content, and a number of available channels.

7. The venue manager of claim 6, wherein the content management function is further configured determine whether the identified media content is to replace media content presently included in the content feed as a result of the analysis.

8. The venue manager of claim 1, wherein the media content is identified based on a selection made at the venue manager.

9. The venue manager of claim 1, wherein the identified media content is content specific to the venue.

10. A media server, comprising:
communications circuitry configured to communicate with a venue manager and with a wireless TV transmitter; and
control circuitry that executes a media content distribution function configured to control content broadcast by the wireless TV transmitter having a geographic coverage area associated with a venue by:
receiving a media content request from the venue manager, the media content request comprising an identity of media content that is to be broadcast within the geographic coverage area associated with the venue, the request instructing the media server to include the identified media content in a content feed sent to the wireless TV transmitter for broadcast in the geographic coverage area associated with the venue; and
sending the identified media content in a content feed to the wireless TV transmitter to be broadcast within the geographic coverage area associated with the venue.

11. The media server of claim 10, wherein media content distribution function is further configured to replace media content presently in the content feed sent to the wireless TV transmitter with the identified media content.

12. The media server of claim 10, wherein the media content distribution function is further configured to multiplex the identified media content with other media content, and the identified media content is sent to the wireless TV transmitter in the content feed as part of a multiplex.

13. The media server of claim 10, wherein the media content is identified based on a broadcast request received from a wireless electronic device located within the geographic coverage area associated with the venue.

14. The media server of claim 10, wherein the media content is identified based on a selection made at the venue manager.

15. The media server of claim 10, wherein the identified media content is content specific to the venue.

16. The media server of claim 15, wherein the media server further comprises a database; and
the media content distribution function is further configured to:
receive the content specific to the venue to the media server in advance of the media content request; and
store the content specific to the venue in the database.

17. An interactive TV transmitter, comprising:
communications circuitry configured to communicate with one or more of a media server and an over-the-air receiver and re-encoder;
a multiplexer configured to multiplex streams of media content;
a wireless TV transmitter configured to broadcast the multiplexed streams of media content in a geographic coverage area associated with a venue; and
control circuitry that executes a media content management function configured to control content broadcast by the wireless TV transmitter in the geographic coverage area associated with the venue by:
identifying media content to be broadcast within the geographic coverage area associated with the venue;
multiplexing the identified media content with other media content using the multiplexer; and
broadcasting the multiplex including the identified media content with the wireless TV transmitter in the geographic coverage area associated with the venue.

18. The interactive TV transmitter of claim 17, wherein the media content management function is further configured to:
transmit a media content request to the media server, the media server comprising the identity of the media content; and
receive a media content response from the media server, the media content response comprising a feed of the identified media content.

19. The interactive TV transmitter of claim 17, wherein the communications circuitry is further configured to communicate with the over-the-air receiver and re-encoder, and wherein the media content management function is further configured to:
transmit a media content request to the over-the-air receiver and re-encoder; and
receive a broadcast from the over-the-air receiver and re-encoder.

20. The interactive TV transmitter of claim 17, wherein media content management function is further configured to replace media content presently in the multiplex sent to the wireless TV transmitter with the identified media content.

21. The interactive TV transmitter of claim 17, wherein the communications circuitry is further configured to communicate with one or more wireless electronic devices located within the geographic coverage area associated with the venue; and
the media content management function is further configured to identify the media content based on a broadcast request received from a wireless electronic device located within the geographic coverage area associated with the venue.

22. The interactive TV transmitter of claim 21, wherein the media content management function is further configured to analyze the broadcast request including the identity of the media content in view of criteria set at the interactive TV transmitter and multiplex the identified media content with other media content using the multiplexer as a result of the analysis, the criteria comprising one or more of access or authorization information, information pertaining to a type of permitted content, and a number of available channels.

23. The interactive TV transmitter of claim 22, wherein the content management function is further configured to determine whether the identified media content is to replace media content presently included in the multiplex as a result of the analysis.

24. The interactive TV transmitter of claim 17, wherein the media content is identified based on a selection made at the interactive wireless TV transmitter.
